(19) United States
(12) Patent Application Publication
(10) Pub. No.: US 2011/0277791 A1
(43) Pub. Date: Nov. 17, 2011

(54) METHOD FOR REMOVING COATINGS FROM SURFACES SUCH AS PAINT APPLICATOR EQUIPMENT

(76) Inventor: Philip J. Beauchamp, Warren, MI (US)

(21) Appl. No.: 12/781,214

(22) Filed: May 17, 2010

(51) Int. Cl. B08B 3/00; C09D 9/00

(52) U.S. Cl. 134/18; 510/201; 134/42

(57) ABSTRACT

The present invention is directed to a method for cleaning paint equipment comprising applying to at least a portion of the paint equipment a cleaning composition comprising a non-aromatic mono-alcohol polyether compound.

### BACKGROUND OF THE INVENTION

1. Field of the Invention

The present invention relates to a method for removing coating residues from a surface, such as the surface of a paint applicator.

2. Background Information

Over the past twenty years, there has been a concerted effort among manufacturers to reduce atmospheric pollution caused by volatile solvents that are released during industrial painting processes. One of the major goals of the coatings industry is to minimize the use of organic solvents by formulating water reducible coating compositions that provide excellent appearance as well as good physical properties. In the automotive industry and in other industrial painting processes, water reducible coating compositions are typically applied to substrates using electrostatic paint sprayers in specially designed paint spray booths. This paint application equipment needs to be cleaned periodically during routine maintenance and color change operations, and when paint formulations are changed. Like the coatings themselves, cleaning compositions used to remove the coatings from the paint spray equipment are more often water reducible compositions, in order to be compatible with the coatings they are being used to remove from the equipment. However, many of these cleaning compositions, despite being water reducible, contain significant levels of organic amines, aromatic compounds, and organic solvents that are known as volatile organic compounds (VOC's).

### SUMMARY OF THE INVENTION

The present invention is directed to a method for cleaning paint equipment comprising applying to at least a portion of the paint equipment a cleaning composition comprising a non-aromatic mono-alcohol polyether compound.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Plural encompasses singular and vice versa. For example, although reference is made herein to “a” non-aromatic mono-alcohol polyether compound a combination (a plurality) of these components can be used in the present invention.

As used herein, “plurality” means two or more.

As used herein, “includes” and like terms means “including without limitation.”

When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “molecular weight” means weight average molecular weight (M_{w}) as determined by Gel Permeation Chromatography.

As used herein, the term “cure” refers to a coating wherein any crosslinkable components of the composition are at least partially crosslinked. In certain embodiments, the crosslink density of the crosslinkable components (i.e., the degree of crosslinking) ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

Reference to any monomer(s) herein refers generally to a monomer that can be polymerized with another polymerizable component such as another monomer or polymer. Unless otherwise indicated, it should be appreciated that once the monomer components react with one another to form a compound, the compound will comprise the residues of the monomer components.

The automotive OEM and/or industrial industries rely heavily on paint equipment, such as paint applicators, during the manufacturing process. This equipment is typically used to paint or coat various objects ranging from automobiles and aircraft to refrigerators. Examples of such a paint applicator include, without limitation, a bell applicator, a handheld paint spray gun, electrostatic spray gun, and/or dip installation. As the paint applicator is used during the painting process, paint begins to deposit on a surface of the applicators, such as the interior walls of the applicator's spray nozzle. Eventually, if the paint deposit is not cleaned from nozzle, the paint deposit will cause the nozzle to clog. While, as stated above, there are methods of cleaning paint deposits from a paint applicator, many of these methods can have a negative impact on the environment.

Accordingly, the present invention is directed to a method of cleaning paint equipment that can reduce and/or eliminate the need to use compounds and materials that are currently seen as being potentially harmful to the environment. Accordingly, the present invention is directed to a method of cleaning paint equipment that comprises applying a cleaning composition comprising a non-aromatic mono-alcohol polyether compound onto at least a portion of a surface that is to be cleaned.

As used herein, “non-aromatic” means that the compound does not contain any aromatic ring structures or groups.

Moreover, the polyether compound disclosed herein is a mono-alcohol. That is, the compound does not contain more than one hydroxyl group.

Accordingly, in some embodiments, the non-aromatic mono-alcohol polyether compound is not a glycol (e.g., a glycol ether).

While the non-aromatic mono-alcohol polyether compound is not a glycol, the cleaning composition of the present invention, in certain embodiments, may further comprise an organic solvent. Suitable organic solvents include glycol, such as glycol ethers, as well as the auxiliary solvents described below. Examples of glycol ethers include ethylene glycol, n-butanol, ethylene glycol monobutyl ether, diethylene glycol n-butyl ether, triethylene glycol methyl ether, propylene glycol normal butyl ether, diproopylene glycol methyl ether, propylene glycol methyl ether, propylene glycol normal propyl ether, or combinations thereof.

In certain embodiments, the non-aromatic mono-alcohol polyether compound can be depicted as structure (I):

CH₃—(CH₂)ₓ—O—(CH₂—CH₂—O)_{y}—H (I)
wherein x can be 4 to 6 and y can be 2 to 10.

In some embodiments, both x and y of structure (I) are 5.

The non-aromatic mono-alcohol polyether compound can be present in the cleaning composition in an amount ranging from 5% to 30% by weight of the non-aromatic mono-alcohol polyether compound based on the total weight of the composition.

In certain embodiments, the cleaning composition can, optionally, contain other materials (additives) such as buffering agents and/or surfactants including defoamers, organic co-solvents, chelators, hydrotropes, alkanolamines, wetting agents, corrosion inhibitors, and/or other customary auxiliaries. Accordingly, examples of some additives that can be used with the present invention include, without limitation, BEROL 500 (available from Akzo Nobel), SURFYNOL (available from Air Products), MIRATANE ASC (available from Rhone-Poulenc), monoethanolamine, diethyl ethanolamine, triethanolamine, disodium metasilicate, or combinations thereof. These materials, either individually or in combination, can constitute up to 50 weight %, such as from 10 weight % to 40 weight %, based on the total weight percent, of the coating composition.

For example, additional surfactant may be needed in some instances to improve initial wetting of the paint to be removed from the target surface. The surfactant may be anionic, non-ionic, cationic or amphoteric in character, but is typically a low foaming surfactant or is used in combination with a defoamer to minimize the amount of foam generated during use. Examples of suitable surfactants that can be used with the present invention include alkylaryl sulfonates such as sodium xylene sulfonate, ethoxylated fatty esters and oils such as MERPOL A (available commercially from E.I. duPont de Nemours & Co.), non-ionic fluorocarbon-based surfactants such as ZONYL FSN (available from E.I. duPont de Nemours & Co.), and non-ionic ethoxylated alkylphenols such as ethoxylated octylphenol. If the water used is very “hard”, meaning that it contains substantial concentrations of calcium and/or magnesium cations, a chelating agent for these ions may be needed to prevent unwanted precipitation of scums on the surfaces being cleaned. Suitable chelating agents include water-soluble compounds containing two or more functional groups such as carboxylic acid groups, phosphoryl groups, amine groups, and/or hydroxyl groups which are arranged in suitable positions in the chelating agent molecule such that atoms in two or more functional groups are capable of complexing with a single calcium and/or magnesium cation. Non-limiting examples of suitable chelating agents include EDTA, gluconic acid, citric acid, polyphosphonic acids, and salts thereof. In some instances for removing especially difficult paints, additional solvent may be needed and may be tolerable even if it increases the VOC content of the composition. The auxiliary solvents are preferably water-soluble and may be selected from, for example, polyalkylene glycols, glycols, glycol ethers, glycol esters, glycol oligomers, aliphatic and aromatic alcohols, ethers, ketones, and the like. Corrosion inhibitors may also be present in the paint-removing compositions of the present invention.

In some embodiments, a chemical buffering agent is included in the cleaning composition. The chemical buffering agent can be any buffering agent or system that provides and helps maintain a pH of the cleaning solution. The buffering agent can be a buffering organic acid or a salt thereof, or an inorganic acid. If the buffering agent utilized is an inorganic acid, the use of a diprotic or triprotic acid is preferred. Inorganic acids that can be used include phosphoric acid and boric acid. Suitable organic acids include gluconic acid, malic acid, glycolic acid, and citric acid.

In certain embodiments, the cleaning composition can also include water, such as tap water, deionized water, or any other source of water (e.g., municipal water). The cleaning composition disclosed herein, therefore, can be supplied in two or more components. For example, in some embodiments, the cleaning composition can be supplied as a concentrate solution that comprises no more than 60% by volume of water. For example, in certain embodiments, the concentrate solution can comprise from 10% by volume to 50% volume of water. In addition to comprising the non-aromatic mono-alcohol polyether compound described above, the concentration solution can also comprise the additives described above as well. The concentrate solution can then be added to water thereby diluting the concentrate solution and forming the cleaning composition disclosed herein. In yet other embodiments, the additives can be post-added to the mixture the mixture of the concentrate and deionized water. Therefore, in this embodiment, the cleaning composition is supplied in three components.

When the cleaning composition comes into contact with the coating residue or paint residue, it promotes the removal of the coating residue via chemical and/or mechanical means. That is, when the cleaning composition comes into contact with the paint residue, it may dissolve all or some of the paint residue thereby removing the paint residue from the surface of the applicator by chemical means. Additionally, it may be possible that the pressure through which the cleaning composition is propelled through the applicator may cause the paint residue to detach from the surface of the applicator thereby cleaning the surface of the applicator through mechanical means.

In some embodiments, the cleaning composition of the present invention may be heated prior to contacting the cleaning composition to the surface of the paint applicator. Accordingly, the cleaning composition may be subjected to a heating step prior to its introduction to the paint equipment. This heating step can be done in order to improve the efficiency of the cleaning composition to remove any paint deposits on the surface of the applicator. When such a heating step is employed, typically the cleaning solution is heated to a temperature ranging from 26° C. to 55° C.

The process disclosed herein may also include a rinsing step wherein water or a mixture of water and other additives are introduced into the paint equipment in order to ensure complete removal of any paint residues. In lieu of the rinsing step, the system can also be purged by introducing high pressure air or nitrogen gas through the paint equipment using techniques that are known in the art.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

In order to attempt to replicate the actual cleaning conditions experienced with today's modern turbo bell applicators, the various solutions of the present invention were tested pursuant to the parameters described below. The solutions were tested by applying paint (in an amount which is listed as “Paint Volume” in Table 2) to the spinning disk, allowing a 30 second dwell time, then applying the cleaning solution (in an amount which is listed as “Test Solution Volume” in Table 2), followed by another 30 second dwell period. This sequence was repeated on the same spinning disk two more times for a total of three sequences, with the last paint application allowed to dwell 15 minutes prior to the final cleaner solution application. The disk was then stopped and evaluated for percent paint removed. The results of the evaluation were reported as percent paint cleaned from the disk where a result of 80 or above was considered a passing result.

TABLE 1

| | | | | | % DMEA | |
|---|---|---|---|---|---|---|
| | | % | % | % | (dimethyl- | % |
| Test | % | Basephor | Surfynol | Surfynol | ethanol- | Butyl |
| solution | Water | HE-50¹ | 440² | 104E³ | amine) | Cellosolve |
| A | 0 | 0 | 0 | 0 | 1 | 99 |
| B | 74 | 10 | 1 | 0 | 5 | 10 |
| C | 64 | 10 | 1 | 0 | 5 | 20 |
| D | 52 | 5 | 1 | 0 | 5 | 37 |
| E | 74 | 10 | 0 | 1 | 5 | 10 |
| F | 64 | 10 | 0 | 1 | 5 | 20 |
| G | 52 | 5 | 0 | 1 | 5 | 37 |
| H | 79 | 15 | 0 | 1 | 5 | 0 |

¹Mono-alcohol polyether surfactant available from BASF Corp.
²Mono-alcohol polyether surfactant available from BASF Corp.
³Non-ionic surfactants available from Air Products & Chemicals, Inc.

TABLE 2

| | Concentration | Test | Test solution | | | Result |
|---|---|---|---|---|---|---|
| | in Water | solution | temperature | Paint applied to | Paint | (% disk |
| Solution | (wt %) | volume | (° F.) | Disk | volume | cleaned) |
| A | 10% | 1.0 ml | 120 | BASF | 0.5 ml | 80 |
| | | | | White | | |
| | | | | E54WW301 | | |
| B | 10% | 1.0 ml | 120 | BASF | 0.5 ml | 98 |
| | | | | White | | |
| | | | | E54WW301 | | |
| C | 10% | 1.0 ml | 120 | BASF | 0.5 ml | 97 |
| | | | | White | | |
| | | | | E54WW301 | | |
| D | 10% | 1.0 ml | 120 | BASF | 0.5 ml | 95 |
| | | | | White | | |
| | | | | E54WW301 | | |
| E | 10% | 1.0 ml | 120 | BASF | 0.5 ml | 98 |
| | | | | White | | |
| | | | | E54WW301 | | |
| F | 10% | 1.0 ml | 120 | BASF | 0.5 ml | 95 |
| | | | | White | | |
| | | | | E54WW301 | | |
| G | 10% | 1.0 ml | 120 | BASF | 0.5 ml | 95 |
| | | | | White | | |
| | | | | E54WW301 | | |
| H | 10% | 1.0 ml | 120 | BASF | 0.5 ml | 85 |
| | | | | White | | |
| | | | | E54WW301 | | |

As Table 2 depicts, the various embodiments of the present invention were all given a passing rating.

What is claimed is:

1. A method for cleaning paint equipment comprising applying to at least a portion of the paint equipment a cleaning composition comprising a non-aromatic mono-alcohol polyether compound.

2. The method according to claim 1, wherein the mono-alcohol polyether compound comprises structure (I):
CH₃—(CH₂)ₓ—(O—(CH₂—CH₂—O)_{y}—H (I)
wherein x can be 4 to 6 and y can be 2 to 10.

3. The method according to claim 2, wherein x is 5 and y is 5.

4. The method according to claim 1, wherein the cleaning composition further comprises water.

5. The method according to claim 1, wherein the cleaning composition comprises 5 to 30% by weight of the non-aromatic mono-alcohol polyether compound based on the total weight of the composition.

6. The method according to claim 1, wherein the cleaning composition further comprises an additive.

7. The method according to claim 1, wherein the additive comprises a solvent, a surfactant, a hydrotrope, a defoamer, an alkanolamine, a wetting agent, or combinations thereof.

8. The method according to claim 7, wherein the additive comprises an alkonolamine.

9. The method according to claim 1, wherein the cleaning composition is applied to at least a portion of a surface of the paint equipment for a time ranging from 1 to 60 seconds.

10. The method according to claim 1, wherein the cleaning composition is applied to at least a portion of a surface of the paint equipment by spray application.

11. The method according to claim 1, wherein the cleaning composition is applied to at least a portion of a surface of the paint equipment by immersion application.

12. The method according to claim 1, wherein the cleaning composition is contacted with at least a portion of a surface of the paint equipment by circulating the cleaning solution through the paint equipment.

13. The method according to claim 1, wherein the cleaning solution is heated to a temperature ranging from 26° C. to 55° C. prior to application to the paint equipment.
